(19) United States
(12) Patent Application Publication
(10) Pub. No.: US 2007/0164909 A1
(43) Pub. Date: Jul. 19, 2007

(54) EMBEDDED ANTENNA OF A MOBILE DEVICE

(76) Inventors: Harry K. Ogawa, Surrey, Province of British Columbia (CA); Robert F. Wilson, Vancouver, Province of British Columbia (CA)

Correspondence Address: NORTH AMERICA INTELLECTUAL PROPERTY CORPORATION, P.O. BOX 506, MERRIFIELD, VA, 22116, US

(21) Appl. No.: 11/306,856

(22) Filed: Jan. 13, 2006

(51) Int. Cl. H01Q 1/24

(52) U.S. Cl. 343/702; 343/873

(57) ABSTRACT

An embedded antenna of a mobile device includes a substrate plate, a straight conductive trace installed on the substrate plate along a first direction, and a rectilinear folded conductive trace electrically connected to an end of the straight conductive trace. The rectilinear folded conductive trace comprises a longest portion installed on the substrate plate along a second direction perpendicular to the first direction, and a shortest portion installed on the substrate plate along a third direction perpendicular to the second direction. A length of the straight conductive trace is longer than a dimension of the rectilinear folded conductive trace in the first direction.

### BACKGROUND OF THE INVENTION

1. Field of the Invention

The present invention relates to an embedded antenna of a mobile device, and more particularly, to a space saving and mechanically robust embedded antenna of a mobile device.

2. Description of the Prior Art

As the related technology keeps improving, mobile devices such as mobile phones or pagers are getting smaller and lighter. For exterior design and other related issues, an antenna may be built inside a housing of a mobile device. However, the interior space of the mobile device is limited. For example, an internal dimension of a compact paging device is usually less than 10 mm in thickness. Therefore, the way of designing a space saving embedded antenna is of key importance.

Please refer to FIG. 1 and FIG. 2. FIG. 1 is a diagram showing a mobile device 100 of the prior art placed in a tabletop orientation, and FIG. 2 is a diagram showing the mobile device 100 of the prior art placed in a holster orientation. Basically, the mobile device 100 is preferably oriented to have the same polarization as a base station in order to maximize communication performance, and most base stations transmit signals of vertical polarization (along a first direction A). In most practical uses, the mobile device 100 is either placed flatly on a table (that is in the tabletop orientation shown in FIG. 1 ) or put inside a holster or pocket (that is in the holster orientation shown in FIG. 2). Therefore, the mobile device 100 must be designed to radiate and receive vertical polarization signals in both tabletop and holster orientations.

Please refer to FIG. 3. FIG. 3 is a diagram showing a whip antenna 310 (refer to U.S. Pat. No. 4,435,713) coupled to a signal feeding point 330 of the RF (radio frequency) printed circuit board 320 of the mobile device 100 of the prior art. To get vertical polarization in both tabletop and holster orientations, a practical solution is coupling the antenna 310 to one side of the RF printed circuit board 320 perpendicularly. Thus the antenna 310 will radiate and receive vertical polarization signals when the mobile device 100 is put in the tabletop orientation, and the RF printed circuit board 320 will work as part of the antenna 310 to radiate and receive vertical polarization signals when the mobile device 100 is put in the holster orientation. However, a total length of a whip antenna 310 must be equal to a quarter wavelength of the transmitting signal, and in a 900 MHz communication system, the total length of the whip antenna 310 must be equal to 83 mm, which means the straight whip antenna 310 is impractical to be installed inside a compact mobile device such as a pager. Therefore, the shape and structure of the whip antenna 310 must be modified to reduce the dimension in a first direction A.

Please refer to FIG. 4 and FIG. 5. FIG. 4 is a diagram showing a helical whip antenna 340 (refer to U.S. Pat. Nos. 5,489,916 and No. 4,800,395) coupled vertically to the signal feeding point 330 of the RF printed circuit board 320 of the mobile device 100 of the prior art, and FIG. 5 is a diagram showing the helical whip antenna 340 coupled horizontally to the signal feeding point 330 of the RF printed circuit board 320 of the mobile device 100 of the prior art. Although the antenna 340 of FIG. 4 can be formed in a helical shape to reduce the dimension in the first direction A (vertical direction), the helical whip antenna 340 is still too big to be used as an embedded antenna. For example, in the 900 MHz communication system, the dimension of the helical whip antenna 340 in the first direction A is equal to 15 mm, which is still too big to be put into a space having a dimension less than 10 mm in the first direction A. As shown in FIG. 5, the dimension of the helical whip antenna 340 in the first direction A can be further reduced by orientating the helical whip antenna 340 horizontally coupled to the RF printed circuit board 320. However, the helical whip antenna 340 of FIG. 5 has poor performance for radiating and receiving vertical polarization signals in the tabletop orientation.

Please refer to FIG. 6 and FIG. 7. FIG. 6 is a diagram showing a vertical meander line whip antenna 350 (refer to U.S. Pat. No. 6,894,646) coupled to the RF printed circuit board 320 of the mobile device 100 of the prior art, and FIG. 7 is a diagram showing a horizontal meander line whip antenna 360 (refer to U.S. Pat. Nos. 6,320,545 and No. 6,459,413) coupled to the RF printed circuit board 320 of the mobile device 100 of the prior art. Even though the meander line is another way to reduce the dimension in the first direction A, however, in the 900 MHz communication system, the dimension of the vertical meander line whip antenna 350 of FIG. 6 is equal to 16 mm in the first direction A, which is also too big to be put into the space having a dimension less than 10 mm in the first direction A. As shown in FIG. 7, the dimension of the horizontal meander line whip antenna 360 in the first direction A is small enough, but the vertical portions 362 (along the first direction A) of the horizontal meander line whip antenna 360 cause current cancellation in each other. Therefore, the horizontal meander line whip antenna 360 has poor performance of radiating and receiving vertical polarization signals in the tabletop orientation.

Please refer to FIG. 8, which shows a billboard antenna 370 (refer to U.S. Pat. No. 6,107,967) coupled to the RF printed circuit board 320 of the mobile device 100 of the prior art. Similar to the above, a dimension of the billboard antenna 370 in the first direction A is over 13 mm at the frequency of 900 MHz, which is impossible to be put into the space having a dimension less than 10 mm in the first direction A. If the dimensions of the billboard antenna 370 are reduced to the required size, its vertical polarization performance in the tabletop orientation is unsatisfactorily low. Besides, the attachment of the billboard antenna 370 made on a single sided printed circuit board is not robust enough to handle shocks, as the printed circuit board trace will crack at the solder junction after impact.

In conclusion, the antennas 310,340,350,360,370 of the prior art are either too big to be embedded into the mobile device 100, or perform badly in the tabletop orientation.

### SUMMARY OF THE INVENTION

It is therefore an objective of the claimed invention to provide a space saving and efficient embedded antenna of a mobile device in order to solve the problems of the prior art. In addition, the antenna must be robustly mounted to withstand shock impacts from dropping the mobile device.

The present invention provides an embedded antenna of a mobile device comprising a substrate plate, a straight conductive trace installed on the substrate plate along a first direction, and a rectilinear folded conductive trace electrically connected to an end of the straight conductive trace. The rectilinear folded conductive trace comprises a longest portion installed on the substrate plate along a second direction perpendicular to the first direction, and a shortest portion installed on the substrate plate along a third direction perpendicular to the second direction. A length of the straight conductive trace is longer than the dimension of the rectilinear folded conductive trace in the first direction.

The present invention further provides a mobile device with an RF circuit board, an embedded antenna, and a housing for accommodating the RF circuit board and the embedded antenna. The embedded antenna comprises a substrate plate coupled to the RF circuit board; a straight conductive trace installed on a main surface of the substrate plate along a first direction perpendicular to a main surface of the RF circuit board, a first end of the straight conductive trace electrically connected to a signal feeding point of the RF circuit board; and a rectilinear folded conductive trace electrically connected to a second end of the straight conductive trace. The rectilinear folded conductive trace comprises a longest portion installed on the substrate plate along a second direction perpendicular to the first direction, and a shortest portion installed on the substrate plate along a third direction perpendicular to the second direction. A length of the straight conductive trace is longer than a dimension of the rectilinear folded conductive trace in the first direction.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram showing a mobile device of the prior art placed in a tabletop orientation.

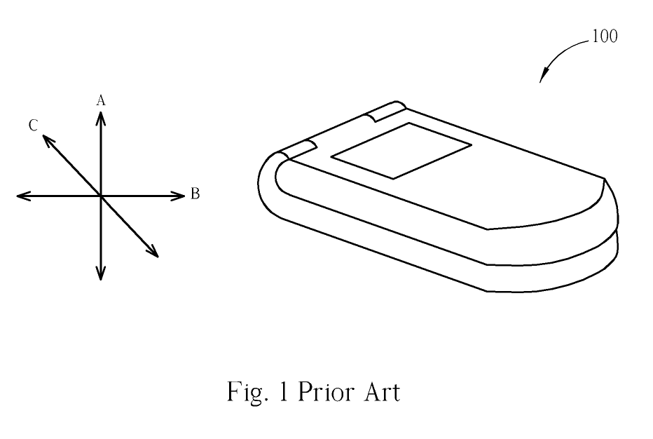

FIG. 2 is a diagram showing the mobile device of the prior art placed in a holster orientation.

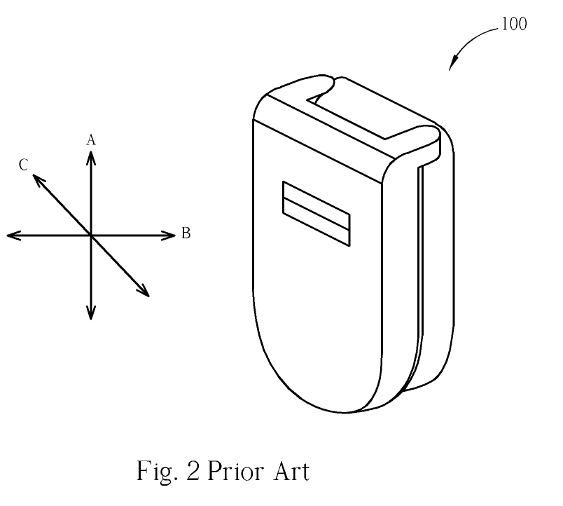

FIG. 3 is a diagram showing a whip antenna coupled to a signal feeding point of an RF printed circuit board of the mobile device of the prior art.

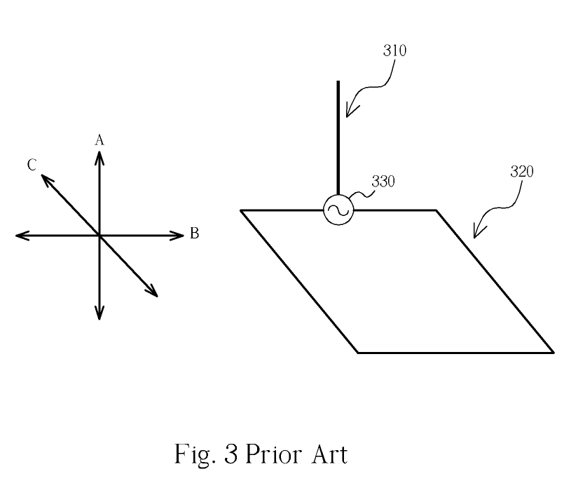

FIG. 4 is a diagram showing a helical whip antenna coupled vertically to the signal feeding point of the RF printed circuit board of the mobile device of the prior art.

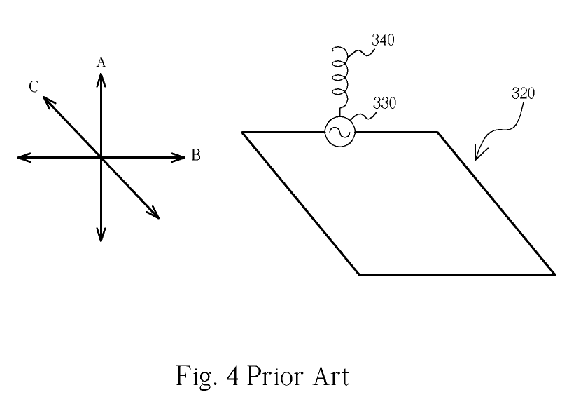

FIG. 5 is a diagram showing the helical whip antenna coupled horizontally to the signal feeding point of the RF printed circuit board of the mobile device of the prior art.

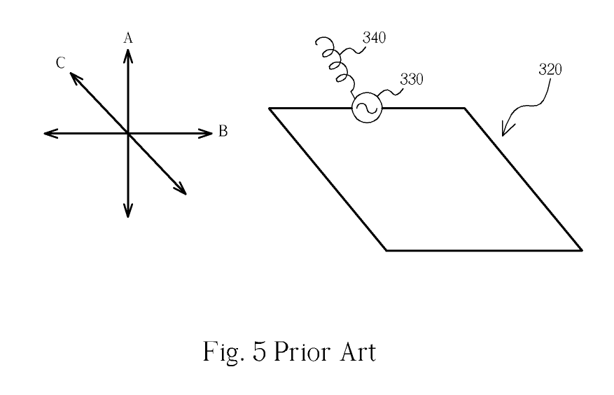

FIG. 6 is a diagram showing a vertical meander line whip antenna coupled to the RF printed circuit board of the mobile device of the prior art.

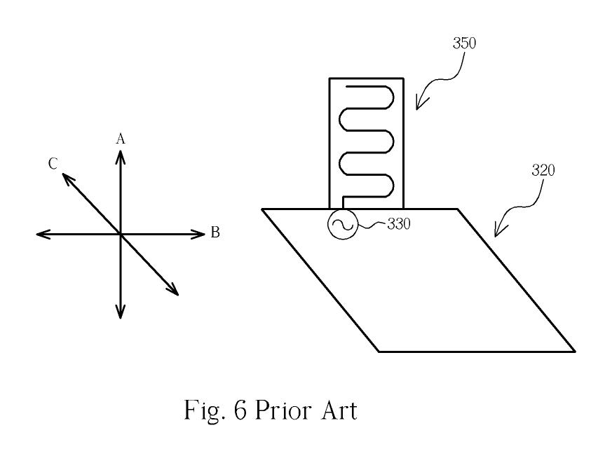

FIG. 7 is a diagram showing a horizontal meander line whip antenna coupled to the RF printed circuit board of the mobile device of the prior art.

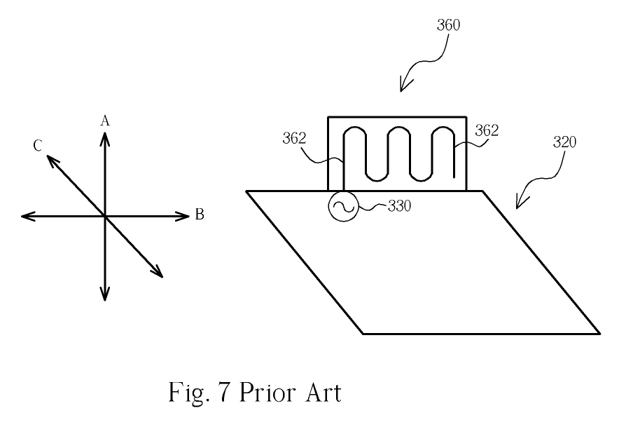

FIG. 8 is a diagram showing a billboard antenna coupled to the RF printed circuit board of the mobile device of the prior art.

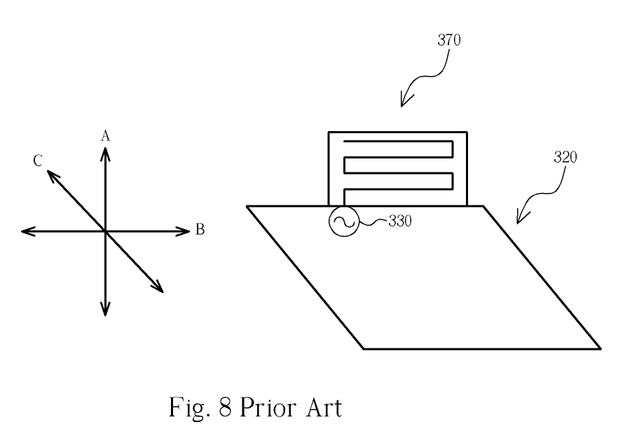

FIG. 9 is a diagram showing a configuration of an embedded antenna of the present invention.

FIG. 10 is a diagram showing the conductive trace of FIG. 9 installed on one side of a printed circuit board of the present invention.

FIG. 11 is a diagram showing the conductive trace of FIG. 9 installed on another side of the printed circuit board of the present invention.

FIG. 12 is a diagram showing another embedded antenna of the present invention.

FIG. 13 is a diagram showing a third conductive traces configuration of the present invention.

FIG. 14 is a diagram showing a fourth conductive traces configuration of the present invention.

FIG. 15 is a diagram showing an embedded antenna coupled to a flexible metal clip pin of the present invention.

FIG. 16 is a diagram showing a cross-sectional view of a mobile device of the present invention.

### DETAILED DESCRIPTION

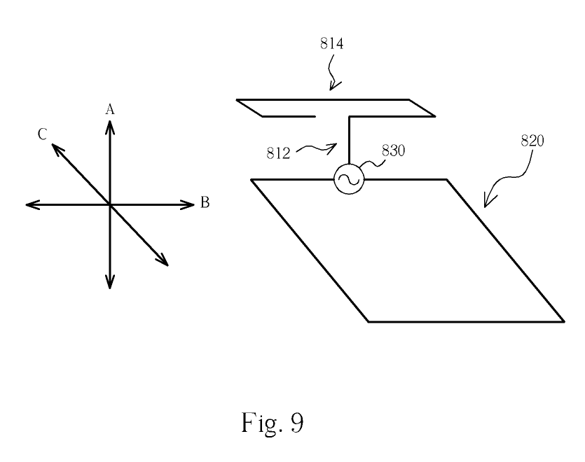

In the present invention, a dimension limit of an embedded antenna is 39 mm long in a second direction B, 9 mm high in the first direction A, and 2 mm thick in a third direction C. Please refer to FIG. 9, which shows a conductive traces configuration of an embedded antenna of the present invention. In an antenna, the current distribution is higher when closer to a signal feeding point. To maximize radiation in vertical polarization, the embedded antenna of the present invention comprises a vertical straight conductive trace 812 (along the first direction A) coupled to the signal feeding point 830 of the RF printed circuit board 820, and the rest of conductive trace 814 with lower current distribution is rectilinearly folded in the second direction B (horizontal direction). Therefore, the embedded antenna of the present not only minimizes the dimension in the first direction A (less than 9 mm), but also maximizes the performance when put in the tabletop orientation.

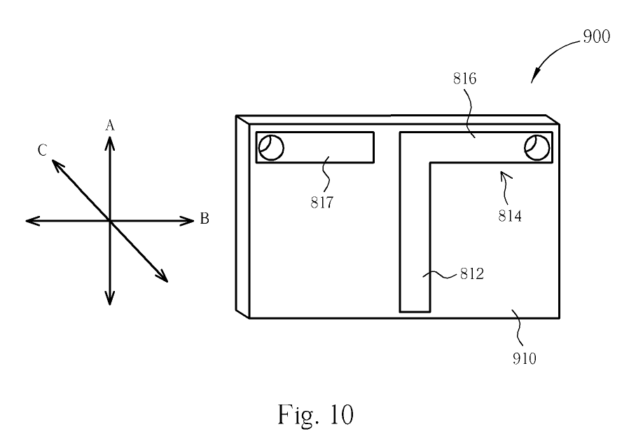

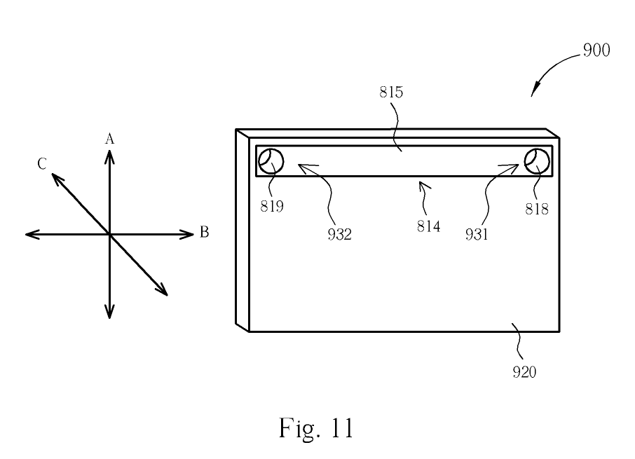

In addition, because the length of a linear antenna is inversely proportional to the square root of dielectric constant, the length of the embedded antenna can be further reduced by etching the conductive traces 812, 814 on a printed circuit board that has a dielectric constant greater than one (nearly four). Please refer to FIG. 10 and FIG. 11. FIG. 10 is a diagram showing the conductive traces 812, 814 of FIG. 9 installed on one side of a printed circuit board 900 of the present invention, and FIG. 11 is a diagram showing the conductive traces 812, 814 of FIG. 9 installed on another side of the printed circuit board 900 of the present invention. As shown in the figures, the straight conductive trace 812 is installed on the top main surface 910 of the printed circuit board 900 along the first direction A, and the rectilinear folded conductive trace 814 comprises five portions: one longest portion 815 installed on the bottom main surface 920 of the printed circuit board 900 along the second direction B, two medium portions 816, 817 installed on the top main surface 910 of the printed circuit board 900 along the second direction B, and two shortest portions 818, 819 installed in through holes 931, 932 of the printed circuit board 900 along the third direction C (perpendicular to the first and second directions A, B).

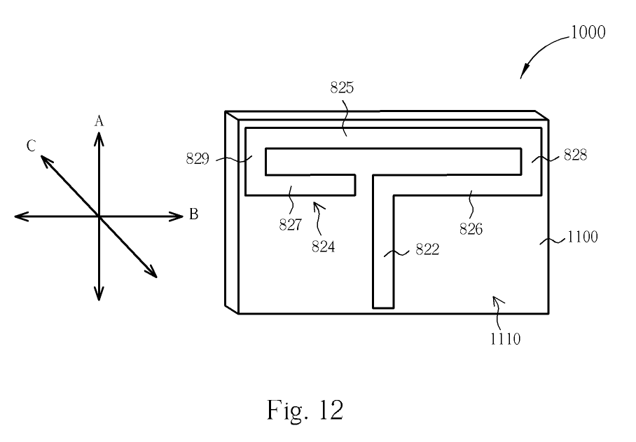

Moreover, because a one-sided printed circuit board without through holes is cheaper than a two-sided printed circuit board with through holes, therefore, to further reduce material and manufacturing costs, both the straight conductive trace and the rectilinear folded conductive trace can be etched on the same main surface of a one-sided printed circuit board. Please refer to FIG. 12, which shows another embedded antenna 1000 of the present invention. As shown in FIG. 12, a straight conductive trace 822 is installed on a top main surface 1110 of a printed circuit board 1100 along the first direction A, and a rectilinear folded conductive trace 824 comprises five portions: one longest portion 825 installed on the top main surface 1110 of the printed circuit board 1100 along the second direction B, two medium portions 826, 827 installed below the longest portion 825 on the top main surface 1110 of the printed circuit board 1100 along the second direction B, and two shortest portions 828, 829 coupled between the longest portion 825 and the medium portions 826, 827 on the top main surface 1110 of the printed circuit board 1100 along the first direction A.

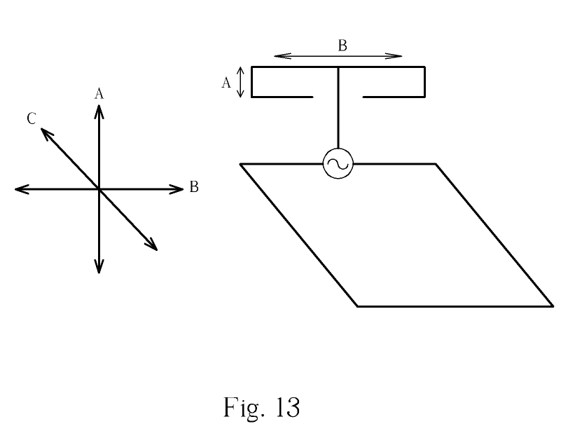

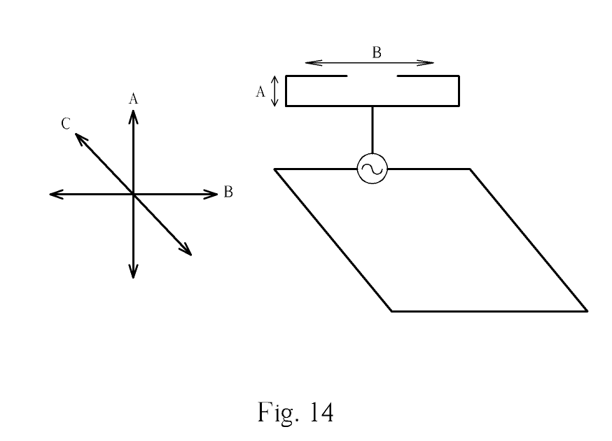

Please refer to FIG. 13 and FIG. 14, which show other conductive traces configurations of the present invention. Because the embodiments in FIG. 13 and FIG. 14 are similar to the above, therefore further description is not provided hereby. However, the conductive traces configurations of the present invention are not limited by the above illustrations, and as long as an embedded antenna comprises a vertical straight conductive trace and a horizontal rectilinear folded conductive trace, it falls within the scope of the present invention.

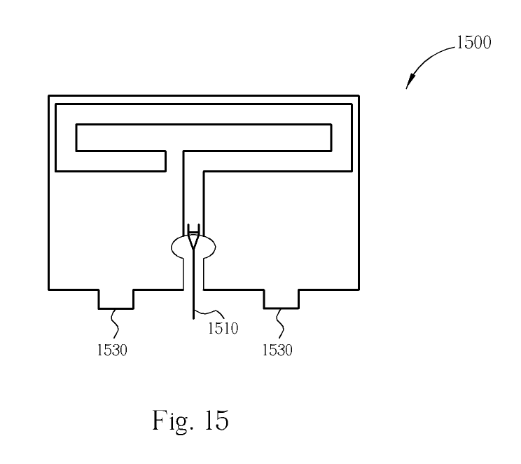

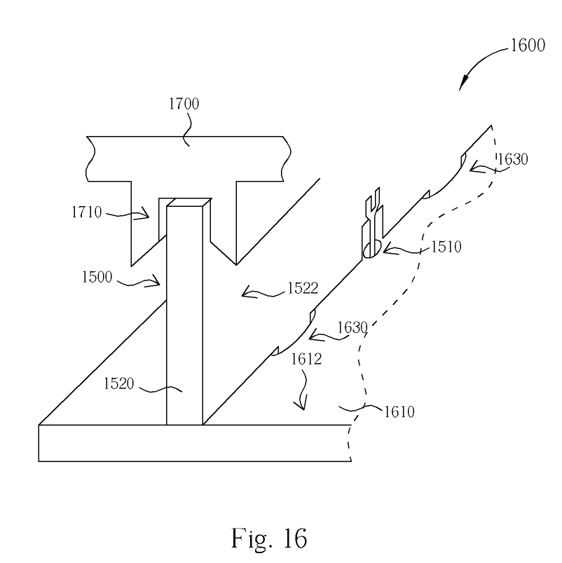

Please refer to FIG. 15 and FIG. 16. FIG. 15 is a diagram showing an embedded antenna 1500 coupled to a flexible metal clip pin 1510 of the present invention, and FIG. 16 is a diagram showing a cross-sectional view of a mobile device 1600 of the present invention. To satisfy product test specifications, a mobile device must withstand a drop test, such as an 1 m drop test. Thus to prevent electrical disconnection between the embedded antenna 1500 and the RF printed circuit board 1610, a flexible metal clip pin 1510 is coupled between the embedded antenna 1500 and the RF printed circuit board 1610. In addition, in order to keep a main surface 1522 of a substrate plate 1520 of the embedded antenna 1500 perpendicular to a main surface 1612 of the RF printed circuit board 1610, two tabs 1530 are formed on the substrate plate 1520 for inserting into holes 1630 of the RF printed circuit board 1610, and a guide 1710 is also formed on a housing 1700 to hold the embedded antenna 1500 in position.

In contrast to the prior art, the embedded antenna of the present invention is space saving and mechanically robust, and the embedded antenna of the present invention not only minimizes the dimension of the embedded antenna in the first direction (vertical direction), but also optimizes communication performance in both the tabletop and holster orientations.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An embedded antenna of a mobile device comprising:
a substrate plate;
a straight conductive trace installed on the substrate plate along a first direction; and
a rectilinear folded conductive trace electrically connected to an end of the straight conductive trace, comprising:
a longest portion installed on the substrate plate along a second direction perpendicular to the first direction; and
a shortest portion installed on the substrate plate along a third direction perpendicular to the second direction;
wherein a length of the straight conductive trace is longer than a dimension of the rectilinear folded conductive trace in the first direction.

2. The embedded antenna of claim 1 wherein the third direction is the same as the first direction.

3. The embedded antenna of claim 1 wherein the third direction is perpendicular to the first and second directions.

4. The embedded antenna of claim 1 wherein the shortest portion of the rectilinear folded conductive trace is installed in a through hole of the substrate plate.

5. The embedded antenna of claim 1 wherein the substrate plate is a printed circuit board.

6. A mobile device comprising:
a RF (radio frequency)circuit board;
an embedded antenna comprising:
a substrate plate coupled to the RF circuit board;
a straight conductive trace installed on a main surface of the substrate plate along a first direction perpendicular to a main surface of the RF circuit board,
a first end of the straight conductive trace electrically connected to a signal feeding point of the RF circuit board; and
a rectilinear folded conductive trace electrically connected to a second end of the straight conductive trace, comprising:
a longest portion installed on the substrate plate along a second direction perpendicular to the first direction; and
a shortest portion installed on the substrate plate along a third direction perpendicular to the second direction; and
a housing for accommodating the RF circuit board and the antenna;
wherein a length of the straight conductive trace is longer than a dimension of the rectilinear folded conductive trace in the first direction.

7. The mobile device of claim 6 wherein the third direction is the same as the first direction.

8. The mobile device of claim 6 wherein the third direction is perpendicular to the first and second directions.

9. The mobile device of claim 6 wherein the shortest portion of the rectilinear folded conductive trace is installed in a through hole of the substrate plate.

10. The mobile device of claim 6 wherein the substrate plate is a printed circuit board.

11. The mobile device of claim 6 wherein the first end of the straight conductive trace is electrically connected to the signal feeding point of the RF circuit board by a flexible metal clip pin.

12. The mobile device of claim 6 wherein a guide is formed on the housing for keeping the main surface of the substrate plate perpendicular to the main surface of the RF circuit board.

13. The mobile device of claim 6 wherein a hole is formed on the RF circuit board, and a tab is formed on the substrate plate for inserting into the hole of the RF circuit board to keep the main surface of the substrate plate perpendicular to the main surface of the RF circuit board.

14. The mobile device of claim 6 being a pager.
